(19) United States
(12) Patent Application Publication
(10) Pub. No.: US 2014/0012513 A1
(43) Pub. Date: Jan. 9, 2014

(54) POPULATION BASED METHOD OF EVALUATING GENOMIC SEQUENCES

(71) Applicants: John Gerald CLEARY, Hamilton (NZ); Stuart John INGLIS, Hamilton (NZ); Sean Alistair IRVINE, Hamilton (NZ)

(72) Inventors: John Gerald CLEARY, Hamilton (NZ); Stuart John INGLIS, Hamilton (NZ); Sean Alistair IRVINE, Hamilton (NZ)

(73) Assignee: REAL TIME GENOMICS, INC., San Bruno, CA (US)

(21) Appl. No.: 13/925,704

(22) Filed: Jun. 24, 2013

Related U.S. Application Data
(60) Provisional application No. 61/729,460, filed on Nov. 23, 2012.

(30) Foreign Application Priority Data
Jun. 25, 2012 (NZ) 600875

(51) Int. Cl. G06F 19/18

(52) U.S. Cl. CPC G06F 19/18
USPC 702/20

(57) ABSTRACT

Methods and systems for evaluating genomic sequences are described. The methods include approaches for evaluating the prevalence of genomes in a sample based on the prevalence of segments in the sample, and may additionally rely on the prevalence of segments in reference genomes and an estimated genome population distribution of the sample.

This application claims the benefit of U.S. Provisional Patent Application No. 61/729,460, filed Nov. 23, 2012, and claims priority to New Zealand Patent Application No. 600875, filed Jun. 25, 2012, each of which is incorporated herein by reference in its entirety.

The present invention relates to a population based method for evaluating genomic sequences and systems therefor. More particularly, although not exclusively, the invention relates to methods for evaluating the correlation between a sample containing multiple genomes and reference genomic sequences where the proportions of different genomes in the sample are unknown.

In nature there are numerous patterns that can be interpreted as sequences of discrete units. In biology, the sequence of nucleotides in DNA or RNA, and the sequences of amino acids in proteins are of particular interest. In DNA, sequences consist of discrete units which may take on one of the values A, C, G, T, while in RNA sequences, the values are A, C, G, and U. Proteins represent a more complicated sequence, as individual units may be one of 21 or more amino acids—in general 22 amino acids.

Sequencing machines are used to produce a machine readable encoding of such biological sequences. These machines use a variety of techniques to interpret the molecular information, and may introduce errors into the data in both systematic and random ways. Errors can usually be categorised into substitution errors, where the real code is substituted with an incorrect code (for example A swapping with G in DNA), or so called indel errors (insertion/deletion), where a random unit is inserted (for example AGT becoming AGCT in DNA) or deleted (for example AGTA becoming ATA).

A sequencing machine may produce a number of ‘reads’, where each read is a small segment of a genome sequence sample, for example a 3 billion unit long DNA collection of chromosomes may be sequenced into reads of only 100 units in length. Due to the method of generating the reads, the original position of each read against the original sequence is unknown, and so mapping and alignment techniques can be used to determine the original location of the reads. Typically alignment will need to take into account that the direction of the reads is also unknown.

Often a sample will contain a mixture of DNA from different organisms (e.g. a sample from a human may contain human DNA, bacterial DNA, viruses etc.). Environmental samples may typically include hundreds or thousands of different genomes, or in some cases tens or hundreds of thousands or even millions.

WO2009/085473 discloses probabilistic matching techniques but does not utilise any population distribution information. Reads are treated as correct and no substitution or indel errors are considered. The probabilistic matching is based simply on the probability of reads matching a reference genome with no appreciation of genome population distribution.

Traditional analysis techniques seek to identify the presence or absence of a specific genomic sequence in isolation. This loses information value that may be obtained from the other nucleotide sequences in the sample. It can be difficult to evaluate the significance of read/reference genome correlations when the relative proportions of reference genomes is unknown.

It would be useful to evaluate to improve the accuracy of correlation between samples and reference sequences using population information or to at least provide the public with a useful choice.

According to a first aspect there is provided a method of evaluating the correlation between a plurality of genomes and segments of a sample based on the prevalence of the segments in the sample, the prevalence of the segments in the genomes and an estimated proportion value for each genome in the sample by optimising the proportion values.

Segments may comprise, e.g., reads obtained from a nucleic acid sequencing, apparatus. In some embodiments, some or all of the reads are paired end reads; in other embodiments, the reads are not paired end reads. Alternatively, segments may comprise fragments of a given length (“K-mers”). Using K-mers that are shorter than reads can allow matching to genomes of related species. This approach may be useful when many of the genomes represented in a sample are not from the same species as the reference genomes.

A probability function may be employed to optimise the proportion values using an iterative process. The probability function may be a Poisson distribution. The probability function may be optimised by moving the iteration in a direction in which the derivative of the probability function is most strongly increasing. The iteration step size may be determined based on the second derivative of the probability function. The iteration step size is determined based on the second derivative of the probability function in the direction that the derivative is most strongly increasing.

The evaluation may be performed for variants of the segments also which may include indels and/or substitutions. The evaluation may also be performed for the reverse complement direction of the segments or variants also. Each variant may have a weighting representing the likelihood of the respective variant occurring. The likelihood may be based at least in part on the apparatus employed or the chemistry of the sample. For example, segments rich or poor in C and/or G nucleotides are selectively favored or suppressed in some sequencing machines. For example, runs of the same consecutive nucleotide can be over or under counted in some sequencing machines. The likelihood of a variant can be adjusted using previously observed rates of these events for a particular sequencing machine and chemistry.

A table of exemplary transition probabilities is shown in Table 1 below. The exemplary transition probabilities represent prior probabilities of X to Y transitions.

TABLE 1

| X to Y | Probability |
|---|---|
| A to A | 0.99897133 |
| T to T | 0.99897329 |
| C to C | 0.99841451 |
| G to G | 0.99841501 |
| A to G | 0.00030100 |
| T to C | 0.00029994 |
| C to T | 0.00037643 |
| G to A | 0.00037624 |
| A to C | 0.00007084 |
| T to G | 0.00007121 |
| C to A | 0.00009541 |
| G to T | 0.00009555 |
| A to T | 0.00005627 |
| T to A | 0.00005571 |
| C to G | 0.00010390 |
| G to C | 0.00010356 |

Segments that do not correlate with the plurality of reference genomes (“unmapped segments”) may be categorised based on paired end reads or not paired end reads etc. Categorisation information may be used to refine proportion values. For example, when a segment that does not correlate with the plurality of reference genomes has a corresponding paired end segment that does correlate, the confidence that the correlated segment was correctly assigned or mapped may be reduced. A similar reduction in confidence may be applied when the members of a pair of paired end reads correlate with different reference genomes. Unmapped segments also provide information about the proportion of the sample which is not represented in the reference genomes. Thus, their abundance can be used to reduce the proportion of known genomes when analysing proportion values with respect to the overall sample.

Unmapped segments may be assembled into composite segments consisting of two or more segments of the same category and the composite segments may be utilised to refine proportion values.

A plurality of algorithms may be employed to determine proportion values. Examples of algorithms which can be used are discussed later in this specification. The algorithms are applied in an order depending upon processing metrics including one or more of: the speed of each algorithm; the precision of each algorithm; the number of segments in the sample; the number of segments in the genomes; the number of genomes; the nature of the sample; the available processing resource; and the required confidence level for the proportion values. Historical probability information of prior samples may also be utilised to assess correlation. For example, historical observations can be used as a starting point or initial guess for proportion values. This approach may be applicable, e.g., for a time series of samples from a site or group of related sites where proportion values from earlier samples have been determined.

Sample segments may be translated into another form and compared to reference segments in that form. For example DNA segments may be converted to protein segments and compared to a reference library of protein segments. In this way, proportion values for individual proteins or pathways (such as metabolic or signalling pathways) involving a plurality of proteins can be determined, instead of or in addition to determining proportion values of genomes.

The correlation between sample genomes and reference genomes obtained may be displayed by displaying regions of correlation between reads and reference sequences. A user may be able to modify correlation parameters such as read length; population distribution; one or more thresholds; read variants to vary the displayed correlation. Correlation may be displayed by colour or some other optical attribute.

There is also provided a method of evaluating correlation between one or more reference genomes and segments of a sample using a probability function based on the prevalence of the segments in a sample, the prevalence of the segments in a plurality of reference genomes and an estimated genome population distribution of the sample.

There is further provided a method of evaluating the correlation between a plurality of genomes and segments of a sample based on the prevalence of the segments in the sample, the prevalence of the segments in the genomes and an estimated proportion value for each genome in the sample by optimising the proportion values.

The sample may be a biological sample (a sample comprising biological material, e.g., protein or nucleic acid) such as a food sample, a water sample or an air sample. The abundance of one or more genome in the biological sample (e.g. genome equivalents per unit mass or volume, or mass of genomic material attributable to the one or more genome per unit mass or volume) may be determined based on the proportion values and the concentration of genomic material in the sample. The sample may be a data sample, i.e., a sample comprising biological sequence segments stored in a computer-readable medium.

There is also provided a method of identifying the source of a sample comprising:
a. obtaining characteristic genome proportion values for one or more source;
b. obtaining genome proportion values for a sample; and
c. comparing the genome proportion values to the one or more source genome proportion values to assess whether the sample is characteristic of a source.

The genome proportion values of the sample are obtained by a method described herein.

And a sample may be considered to be characteristic of a source if comparison is within a prescribed confidence level.

According to another aspect there is provided a method of evaluating the correlation between one or more reference genomes and a sample comprising the steps of:
a. obtaining a set of segments of the sample;
b. identifying segments contained in the reference genomes; and
c. maximising a probability function based on:
   i. the number of occurrences of each segment identified in step b in each reference genome; and
   ii. proportion values of each respective reference genome in the sample by optimisation of the proportion values.

There is further provided a method of displaying the correlation between sample genomes and reference genomes obtained by a method as described above by displaying regions of correlation between reads and reference sequences.

A user may modify one or more correlation parameters to investigate relationships. A user may set a global probability range and explore values within that range. Alternatively a user may modify read length; population distribution; one or more thresholds or read variants. The degree of correlation may be indicated by a visual attribute of each region, such as colour.

There is also provided a first system for determining the genomic population distribution of a sample including:
a. a sequencer to obtain reads from a sample;
b. a first database of reference genome segments; and
c. a first processing engine for determining proportion values of the reference genomes occurring in the sample by optimising the proportion values.

The processing engine may apply a number of algorithms in an order depending upon processing metrics such as: the number of segments in the sample; the number of segments in the genomes; the number of genomes; the nature of the sample; the available processing resource; the required confidence level for the proportion values.

According to a further aspect there is provided a distributed processing system including a first system as above and a second system in communication with the first system, the second system including:
a. a second database storing reference genome segments not stored in the first database; and
b. a second processing engine for processing segments received from the first system using the second database to develop proportion values.

Processing may be transferred from the first system to the second system when the required processing exceeds a metric of the first processing system such as processing capacity; estimated job run time; required proportion values confidence level etc.

The second processing engine may utilise algorithms and/or genome segments not available to the first processing engine.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

To facilitate the understanding of this invention, a number of terms are defined below. Terms not defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

In this specification the term “segment” is used to refer to part of a biological sequence (e.g. a genomic, mRNA, or protein sequence) that may be a “read” from a sequencer or a part of a known genomic, mRNA, or protein sequence or some other part of a larger sequence.

The term “processing engine” as used herein refers to a device or system, such as a computer, which can perform calculations, data manipulation, and the like; neither the human mind nor a human with writing instrument and paper are a processing engine for purposes of this specification.

A generalised method of using genomic population distribution information of a sample will be described to illustrate key principles. In this generalised example a physical sample containing multiple genomes is sequenced to produce a series of reads (segments). Based on the number of occurrences of each unique read there will be a prevalence factor associated with each read. For a library of known genomes each genome will have associated prevalence factors for each unique read (segment). By adjusting estimated proportions of each genome within the sample a “best fit” can be calculated. “Best fit” generally refers to the optimal set of proportion values among the sets evaluated by the method, not necessarily the optimum among all possible sets of proportion values.

As illustrated in a simplified example in Table 2 below a first estimate of the population distribution of the genomes listed under the “Species” heading is estimated in iteration ITER1. For this population distribution a probability function can calculate a global probability L based on the prevalence of segments in the sample (“reads”) and the known prevalence of those segments in the respective genomes.

TABLE 2

| Species | ITER1 | ITER2 | ITER3 | ITER4 | ITER5 |
|---|---|---|---|---|---|
| A | 0.8 | 0.85 | 0.84 | 0.84 | 0.84 |
| B | 0.1 | 0.05 | 0.06 | 0.06 | 0.065 |
| C | 0.01 | 0.01 | 0.01 | 0.01 | 0.01 |
| D | 0 | 0 | 0 | 0.01 | 0.01 |
| E | 0.09 | 0.09 | 0.09 | 0.08 | 0.085 |
| L | 0.9 | 0.91 | 0.92 | 0.93 | 0.935 |

In a second iteration ITER2 the population distribution is adjusted and a new global probability L is calculated. The population distribution is adjusted through successive iterations to ITER5 where an optimised global probability value is achieved. A global probability value can be considered optimised based on achieving a predetermined threshold confidence level, or based on convergence of iterations within a specified level of tolerance.

The first estimate or initial guess may be obtained in any suitable manner, for example, using a uniform distribution, using a historically observed set of proportion values or an average or median of a set of such sets, using proportion values based on frequencies of reads that map uniquely to a reference genome, or using proportion values from overall frequencies of reads mapping to each reference genome. Thus, methods to form the first estimate of the population distribution include the weighted proportion of the segments in the genomes; the proportion of segments uniquely assigned to the genomes; or a uniform distribution. When using the weighted proportion of the segments in the genomes, if a segment r hits s genomes, then it contributes r/s to each of the genomes it hits and 0 to all the others. The initial estimates are then the sum of all these r/s across all r, divided by the total number of segments. In some embodiments, the number of hits per genome may be assumed to be non-zero (e.g., 1 hit), which may improve convergence of iterative methods.

This is a highly simplified example to illustrate the general principle. It will be appreciated that by utilising additional information and potential constraints relating to non-target genomic sequences a population distribution may be obtained that enables a more accurate determination of the prevalence of a target genome to be determined as information as to non-target genomes may constrain the range of probabilities for target genomes. This may be particularly useful where, in addition to proportion values, the likelihood that one or more particular genomes are present in a sample and/or a confidence interval for one or more of the proportion values is to be determined.

Whilst population distribution could be estimated by a brute force technique this would be very computationally inefficient where high numbers of genomes are present. The number of known genomes is increasing quickly, so a desirable attribute of a method would be one that scales up to handle potentially hundreds of millions of species. A brute force method may calculate all values of a probability function for stepped proportions of every genome and refine searching at smaller steps near maxima of each iteration. Where very large numbers of genomes are involved (often tens of thousands in e.g. physical samples found in nature and data samples derived from such physical samples) the computational requirements for a brute force approach may be prohibitive.

A preferred approach evaluates the correlation between a plurality of genomes and segments of a sample based on the prevalence of the segments in the sample, the prevalence of the segments in the genomes and an estimated proportion value for each genome in the sample by optimising the proportion values using a probability function.

A “hill climbing” technique is one way to optimise the probability function to obtain optimised proportion values. The problem for estimating genome frequencies can be formulated in a way that leads to a function f(x1, x2, x3, . . . xn) where n is the number of genome frequencies to be estimated and x1 . . . xn are the frequencies. We want to find the values of x1, x2, x3, . . . xn such that f is as large as possible (its maximum). Where f has a single maximum (peak) in its value (i.e. no small local maxima (peaks) which are lower than the main peak) the following approach may be employed. The derivative of the function represents slope and the second derivative represents the curvature of f with respect to each of x1, x2, x3, . . . xn. As n can be large (in the thousands and potentially in the millions) there can be practical difficulties in finding the peak and ensuring numerical stability unless a directed approach is employed. The peak is the place where all the derivatives are zero (the top of a hill is flat, i.e. not sloped upward or downward) although the second derivatives will usually not be (the peak has a curve in the ground, i.e. curvature is present).

To find a maximum of function f computation starts at a start position (some value of x1, x2, x3, . . . xn) and the derivative at this point is calculated and then successive iterations move in the direction where the derivative is most strongly increasing (i.e. move directly upslope). To be clear, the derivative calculated in this step is a vector quantity, as opposed to a scalar derivative. This can be repeated through several iterations. If the derivative is below a selected threshold then an acceptable solution for the proportion values x1 to xn has been found. The threshold may be evaluated with respect to a scalar determined from the partial derivatives, e.g., the sum of the squares of the partial derivatives or the square root thereof; or the threshold may be evaluated with respect to each partial derivative individually. The step size can be computed using both the derivative and the second derivative using Newton's method. This method both calculates the direction to move and how far you move. However, there may be difficulties with numerical stability in some cases, especially when the first partial derivatives are almost zero (i.e. close to the top of a hill where the slope gets relatively flat) and when the first partial derivatives in different directions are very different (i.e. at a ridge where the top of the ridge slopes gently and the slopes to either side are very steep).

A further refinement uses the derivative to select a direction to move. The direction to move may be determined using the first derivative of f as described above. Then a new function g(xd) representing a slice through f in the chosen direction may be used to determine step size. In this way there is a single number xd which may be varied to find a maximum (this isn't necessarily the top of the hill—just the best we can do in the direction chosen). The first and second derivatives of g may then be calculated. At the chosen starting point, which is set so that xd=0, we know that the first derivative of g(xd) is positive. We then choose a small step and evaluate g(xd) at that point and keep doubling the step until g(xd) becomes negative (i.e. where we have passed the point where it is 0). From these values can be determined lower and higher values for xd and it is known that the best value for g (the point where the derivative is zero) lies between these two values. Newton's method (a simple version that only varies one number) may then be used to find the peak for g(xd). Once this value is obtained a new position x1, x2, x3, . . . xn is obtained for the next iteration. This continues until the first derivative of function f is below a selected threshold value.

By way of simple analogy in three dimensional space the form of the surface will have a significant impact upon the reliability of the optimisation. For example if the surface has a large plateau then there are a number of proportions close to the optimised value with very similar probabilities. Using a graphical interface the nature of the topology may be presented to a user. This may require dimension reduction techniques to create a visual display that is meaningful to a user. It could be an arbitrary representation in which the values lie within a desired global probability range. However, continuing with the simplified 3D example a user may view a hill with a large plateau. The user may be able to navigate around the plateau using a mouse or other input device. As a user navigates to different points certain information associated with the selected point may be displayed—for example the proportions of two target genomes. This enables a user to explore a range of proportions with similar probabilities to see if there is a surprising result or a result that a user can determine to be a better result due to user knowledge (i.e. knowledge that certain proportions are impossible or unlikely or are likely).

A more detailed discussion of the mathematical basis for probabilistic optimisation is provided below. In addition to the hill climbing technique described above the use of a Hessian matrix is also discussed.

### Hill Climbing Example

h is an index over units that can potentially be matched against the genomes. These might be individual exactly matching hashed words or best matching reads.

Definition 1. nₕ

nₕ=number of occurrences of h in the reads.

Care is needed as we must deal correctly with the case when nₕ=0; that is, a unit that is in one or more genomes but which is not seen in the sample.

Definition 2. m_{h,i}

m_{h,i}=number of occurrences of h in the ith genome.

Definition 3. \hat{r}ᵢ

\hat{r}ᵢ=the estimate of the number of occurrences of the ith genome in the reads.

That is \hat{r}ᵢ is an unnormalized count of the number of individuals with the genome in the sample.

Definition 4. ρₕ

$${ρ}_{h} = {\sum }_{k} {m}_{h} , {}_{k}^{}{r}{}_{k}^{} .$$

Definition 5. P

$$P = {\prod }_{h} \frac{{e}^{- {ρ}_{h}} {ρ}_{h}^{{n}_{h}}}{{n}_{h} !} .$$

The global probability of a particular assignment of estimates assumes a Poisson distribution.

Definition 6. L

$$L = - ln ( P ) = - {\sum }_{h} - {ρ}_{h} + {n}_{h} ln ( {ρ}_{h} ) - ln ( {n}_{h} ! ) .$$

L is the negative log of the global probability of a particular assignment of estimates. We will be looking for the minimum which can be found by setting the partial derivatives to 0. Using the negative means that in later steps the Hessian will be a positive definite number (rather than negative definite) which fits the usual conventions in the literature.

We will alter the convention for the summations here. Let h range over units where nₕ>0 and h′ over all units, that is nₕ′≧0. Also note that the terms ln(nₕ!) are constant (independent of \hat{r}ᵢ) so can be ignored for the purposes of minimization and that nₕ′ ln(ρh′)=0 when nₕ′=0.

$$\begin{matrix}L = {\sum }_{{h}^{′}} {ρ}_{{h}^{′}} - {\sum }_{h} {n}_{h} ln ( {ρ}_{h} ) \\ = {\sum }_{{h}^{′}} {\sum }_{k} {m}_{{h}^{′}} , {}_{k}^{}{r}{}_{k}^{} - {\sum }_{h} {n}_{h} ln ( {ρ}_{h} ) \\ = {\sum }_{k} {r}_{k} {\sum }_{{h}^{′}} {m}_{{h}^{′} , k} - {\sum }_{h} {n}_{h} ln ( {ρ}_{h} ) \\ = {\sum }_{k} {r}_{k} {l}_{k} - {\sum }_{h} {n}_{h} ln ( {ρ}_{h} )\end{matrix}$$

where lₖ=Σ_{h′}m_{h′,k} and is in most cases well approximated by the length of the genome k.

Also note that if we sum over all occurrences of h then the value of L is unchanged and effectively each nₕ=1. So our final expression for L the function to be minimized is:

$$L = {\sum }_{k} {r}_{k} {l}_{k} - {\sum }_{h} ln ( {ρ}_{h} )$$

There are many techniques for minimizing functions with varying complexity, robustness and execution time. Many of them require knowledge of the first and/or second derivatives of the function. The first point to note is that the minimum can be defined by the point(s) where the first partial derivatives are zero.

$$\begin{matrix}\frac{\partial L}{\partial \hat{{r}_{i}}} = {\sum }_{k} \frac{\partial }{\partial \hat{{r}_{i}}} {r}_{k} {l}_{k} - {\sum }_{h} \frac{\partial }{\partial \hat{{r}_{i}}} ln ( {\sum }_{k} {m}_{h} , {}_{k}^{}{r}{}_{k}^{} ) \\ = {l}_{i} - {\sum }_{h} \frac{{m}_{h , i}}{{ρ}_{h}} \\ = 0\end{matrix}$$

Minimizing technique 1: Direct Non-linear

A direct non-linear technique may proceed in two steps: first a direction in which to move is determined and then the minimum for L is found along that direction. This procedure is repeated until some acceptable convergence criterion has been satisfied. In terms of the literature for solving such equations the first derivatives are called the Jacobian and written

$${J}_{i} = \frac{\partial L}{\partial \hat{{s}_{i}}} .$$

The basic principle is that the direction should be opposite to J, that is Δ=−J. Then the problem is to find the minimum at δΔ where δ≧0.

Minimizing technique 2: Multi-dimensional Newtons

Solving this requires the additional constraints that \hat{r}ᵢ≧0 which would need the use of Lagrange multipliers. To simplify this and remove the need to explicitly deal with these constraints, the problem can be reformulated in terms of the variables ŝᵢ.

Definition 7. ŝᵢ

ŝᵢ=ln(\hat{r}ᵢ).

Recalling that ρₕ=Σₖ m_{h,k}e^{ŝ}^{ₖ} we can reformulate the problem to

$$\begin{matrix}\frac{\partial L}{\partial \hat{{s}_{i}}} = {\sum }_{k} \frac{\partial }{\partial \hat{{s}_{i}}} {e}^{{\hat{s}}_{k}} {l}_{k} - {\sum }_{h} \frac{\partial }{\partial \hat{{s}_{i}}} ln ( {ρ}_{h} ) \\ = {e}^{\hat{{s}_{i}}} {l}_{i} - {\sum }_{h} \frac{\partial }{\partial \hat{{s}_{i}}} ln ( {\sum }_{k} {m}_{h} , {}_{k}^{}{e}{}_{}^{{\hat{s}}_{k}} ) \\ = \hat{{r}_{i}} {l}_{i} - {\sum }_{h} \frac{{m}_{h} , {}_{i}^{}{e}{}_{}^{{\hat{s}}_{i}}}{{ρ}_{h}} \\ = \hat{{r}_{i}} {l}_{i} - {\sum }_{h} \frac{{m}_{h} , {}_{i}^{}{\hat{r}}{}_{i}^{}}{{ρ}_{h}} \\ = {\hat{r}}_{i} ( {l}_{i} - {\sum }_{h} \frac{{m}_{h , i}}{{ρ}_{h}} ) \\ = 0\end{matrix}$$

In terms of the literature for solving such equations the first derivatives are called the Jacobian and written

$${J}_{i} = \frac{\partial L}{\partial \hat{{s}_{i}}} .$$

Some minimization techniques also require the second derivatives which forms a matrix called the Hessian matrix which is written:

$$\begin{matrix}{H}_{i , j} = \frac{{\partial }^{2} L}{\partial \hat{{s}_{i}} \partial \hat{{s}_{j}}} \\ = \frac{\partial }{\partial \hat{{s}_{j}}} {e}^{{\hat{s}}_{i}} {l}_{i} - {\sum }_{h} {m}_{h , i} \frac{\partial }{\partial {\hat{s}}_{j}} \frac{{e}^{{\hat{s}}_{i}}}{{ρ}_{h}}\end{matrix}$$

Split into two cases when i=j and i≠j.

$$i \neq j$$

$$\begin{matrix}{H}_{i , j} = {\sum }_{h} {m}_{h , i} \frac{{e}^{{\hat{s}}_{i}}}{{( {\sum }_{k} {m}_{h} , {}_{k}^{}{e}{}_{}^{{\hat{s}}_{k}} )}^{2}} {m}_{h , j} {e}^{{\hat{s}}_{j}} \\ = {\sum }_{h} \frac{{m}_{h} , {}_{i}^{}{\hat{r}}{}_{i}^{} {m}_{h} , {}_{j}^{}{\hat{r}}{}_{j}^{}}{{ρ}_{h}^{2}} \\ = {\sum }_{h} \frac{{m}_{h} , {}_{i}^{}{\hat{r}}{}_{i}^{}}{{ρ}_{h}} \frac{{m}_{h} {}_{j}^{}{\hat{r}}{}_{j}^{}}{{ρ}_{h}}\end{matrix}$$

$$i = j$$

$$\begin{matrix}{H}_{i , i} = {\hat{r}}_{i} {l}_{i} - {\sum }_{h} {m}_{h , i} ( \frac{{e}^{{\hat{s}}_{i}}}{{\sum }_{k} {m}_{h} , {}_{k}^{}{e}{}_{}^{{\hat{s}}_{k}}} - \frac{{e}^{{\hat{s}}_{i}}}{{( {\sum }_{k} {m}_{h} , {}_{k}^{}{e}{}_{}^{{\hat{s}}_{k}} )}^{2}} {m}_{h} , {}_{i}^{}{e}{}_{}^{{\hat{s}}_{i}} ) \\ = {\hat{r}}_{i} {l}_{i} - {\sum }_{h} {m}_{h , i} ( \frac{{\hat{r}}_{i}}{{ρ}_{h}} - {m}_{h , i} \frac{{\hat{r}}_{i}^{2}}{{ρ}_{h}^{2}} ) \\ = {\hat{r}}_{i} {l}_{i} - {\sum }_{h} \frac{{m}_{h} , {}_{i}^{}{\hat{r}}{}_{i}^{}}{{ρ}_{h}} + {\sum }_{h} {( \frac{{m}_{h} , {}_{i}^{}{\hat{r}}{}_{i}^{}}{{ρ}_{h}} )}^{2}\end{matrix}$$

Using the convention that J_{i,i}=Jᵢ and letting

$${G}_{i , j} = {\sum }_{h} \frac{{m}_{h} , {}_{i}^{}{\hat{r}}{}_{i}^{}}{{ρ}_{h}} \frac{{m}_{h} , {}_{j}^{}{\hat{r}}{}_{j}^{}}{{ρ}_{h}}$$

for both cases when i=j and i≠j then we can write:

H=J+G

From “Numerical Recipes in C”, Press W.H., Teukolsky S. A., Vettering W. T., Flannery B. P. 2nd edition, 1992, Cambridge University Press, Section 10.6, pp 420-425, we can construct a multi-dimensional Newton's method to iteratively solve the equation J=0. The increment A at each step (the increments apply to ŝᵢ not to \hat{r}ᵢ) is computed as:

HΔ=−J

The conjugate gradient technique is applicable here (as H is symmetric and definite positive). This is a technique which estimates Δ directly without needing to form the inverse H⁻¹ explicitly. There is a description and worked example in http://en.wikipedia.org/wiki/Newton's_method_in_optimization and in Section 2.7 pp 83-89 of “Numerical Recipes in C” (all references to page and section numbers in Numerical Recipes in C refer to Press et al., NUMERICAL RECIPES IN C: THE ART OF SCIENTIFIC COMPUTING, Cambridge Univ. Press, 2d Ed., 1992, which is incorporated herein by reference). More sophisticated techniques are dealt with in Section 10.6 pp 420-425 of “Numerical Recipes in C”

Such an iterative method requires a starting point. There are a number of ways we could do this (also discussed above). One would be to set all the ŝᵢ=0 which is the same as setting \hat{r}ᵢ=1.

To arrive at another consider the special case when each unit h is mapped once or more to just one genome. Then

$$\begin{matrix}\frac{\partial L}{\partial \hat{{r}_{i}}} = {l}_{i} - {\sum }_{h} \frac{{m}_{h , i}}{{m}_{h} , {}_{i}^{}{\hat{r}}{}_{i}^{}} \\ = {l}_{i} - {\sum }_{h} \frac{1}{{\hat{r}}_{i}} \\ = {l}_{i} - \frac{1}{{\hat{r}}_{i}} {\sum }_{h \text{:} {m}_{h , i} > 0} 1\end{matrix}$$

$$Let {m}_{i} = {\sum }_{h \text{:} {m}_{h , i} > 0} 1$$

and then we need to solve

$${l}_{i} - \frac{{m}_{i}}{{\hat{r}}_{i}} = 0 ;$$

that is,

$${\hat{r}}_{i} = \frac{{m}_{i}}{{l}_{i}}$$

To generalize this we redefine

$${m}_{i} = {\sum }_{h} ( \frac{{m}_{h} , i}{{\sum }_{k} {m}_{h , k}} )$$

One variation is to let the \hat{r}ᵢ range over both the actual species that are known and inner nodes on the phylogenetic tree. The m_{h,i} for these pseudo-species would be an average of the m_{h,i} for its children. This may give estimates of the probability that there is an unknown species which is in the clade. Also the sum of the nₕ where all the m_{h,i} are zero may give an estimate of how many completely unknown species there are.

The “hill climbing” technique discussed previously may be employed with appropriate modifications.

Iteration may be performed by a completely automated algorithm or may be user guided. A user may define control parameters such as an acceptable slope threshold or may be presented with interim results to set parameters for further iterations.

As well as performing optimisation of the proportions of genomes based only on the actual reads for a sample optimisation may also be performed for variants of the reads. These variants may include indels and/or substitutions and/or more complex structural/large-scale variations.

Optimisation may also be performed for the reverse complement direction of the reads or variants also as sequences may be read in either direction by a sequencing machine (known as nucleotide bias).

Each variant may be ascribed a weighting representing the likelihood of the respective variant occurring. This likelihood may be based at least in part on characteristics of the apparatus employed (it is known that different sequencing machines have different propensities for generating certain read errors).

The likelihood may also be based at least in part on the chemistry of the sample. There are known to be different likelihoods of errors in relation to different base sequences.

The sample segments (such as reads) may also be translated into another form and compared to reference segments in that form. For example the sample may comprise or consist of DNA or RNA and the DNA or RNA segments may be converted to protein segments and compared to a library of protein segments. The protein segments may thus be used to assess the prevalence of proteins encoded and/or expressed in the sample by a process comprising comparing the protein segments to a library of protein segments.

“Unmapped reads” (i.e. segments or “reads” that are not present in a library of genome segments) may also be utilised to refine proportion values. By categorising unmapped reads additional information can be obtained that can assist in refining proportions. As one example, unmapped reads can be categorised as “paired end reads” when the reads were generated by a suitable sequencing procedure. The relative amount of unmapped reads can be used to estimate the proportion value for unidentified genomes, genomes of species other than the sources of the reference genomes, or genomes from organisms that are phylogenetically distant from the sources of the reference genomes.

RNA sequences are transcribed in some cells from a series of “exons” that are not continuous on the genome, but are separated by “introns”.

Which exons are actually included during splicing can vary which leads to different “splice variants”, that is one gene can lead to multiple different RNA variants which then translate into non-identical proteins.

One important problem when analyzing RNA sequences such as metazoan, e.g. mammalian, RNA sequences, where alternative splicing and splice variants are relatively common, is to estimate the relative frequency of each of these different possible splice variants. Such splice variants are similar to species in a metagenomics sample in that a read can map to one or more different splice variants just as it might map to one or more species. Thus it is possible to estimate the frequency of the splice variants in the same way that the frequency of species or proteins is estimated.

Further processing may include assembly of two or more segments into a composite segment and analysing the composite segment against the library of genome segments. Paired end reads naturally make good candidates for assembly. Exons may also be assembled in the composite segments due to their importance. Other categorised segments may also be combined based on their phylogeny and relevance to any target genomes.

A number of algorithms may be employed to determine proportion values and the order of application may be predetermined or based upon processing metrics such as the speed of the algorithm; the precision of each algorithm; the number of segments in the sample; the number of segments in the genomes; the number of genomes; the nature of the sample; the available processing resource; and the required confidence level for the proportion values.

The proportion results may be utilised to estimate the concentration of different genomes in a sample or to provide population distribution information for a number of genomes. Concentration or “abundance” values may be obtained by estimating the concentration of all genomic material in a sample (the total amount of DNA may be calculated by using an optical spectrometry procedure that calculates the change in light passing as a function of the amount of DNA present) and utilising the proportion values to determine the concentration of a particular genome in a sample. This method may be particularly suited for use in monitoring food, air and water samples.

The method may also be used to provide a fingerprint of a source. Each source may have a characteristic genomic population distribution. This may be used for food tracing etc. By obtaining a characteristic genome proportion values for one or more source and comparing this with genome proportion values for a sample an assessment can be made as to whether the sample is characteristic of a source. A sample may be considered to be characteristic of a source if comparison is within a prescribed confidence level.

Historical probability information from prior samples may also be utilised to assess correlation.

The correlation between sample genomes and reference genomes obtained by a method as described above may be graphically displayed by displaying regions of correlation between reads and reference sequences. A user may modify correlation parameters to see the change in correlation results. Parameters a user may modify may include: read length; population distribution; thresholds; and read variants.

The degree of correlation may be indicated by a visual attribute of each region, such as colour.

The invention also encompasses methods of obtaining expression levels of related genes in a mixed population. This may be achieved by using a processing engine to optimise estimated proportion values for the related genes based on input data comprising the prevalence of segments of the related genes in a mixed sample, the prevalence of the segments in the genomes of the population, and the prevalence of the genomes of the population in the mixed sample, thereby producing optimised proportion values for the expression levels of the related genes in the mixed population. The invention further encompasses a method of obtaining expression levels of related genetic pathways in a mixed population, the method comprising using a processing engine to optimise estimated proportion values for the related genetic pathways based on input data comprising the prevalence of segments of genes in the related genetic pathways in a mixed sample, the prevalence of the segments in the genomes of the population, and the prevalence of the genomes of the population in the mixed sample, thereby producing optimised proportion values for the expression levels of the related genetic pathways in the mixed population. The populations may be, e.g., microbial populations, which may include one or more of protists, bacteria, archaea, viruses, fungi, etc. The populations may also be a sample from a multicellular organism, such as a mammal, e.g., a human, which contains cells of different types (blood cells, stem or progenitor cells, connective tissue cells, neurons, glia, endothelial and epithelial cells, and organ-specific cells such as splenocytes, hepatocytes, etc.) and/or microbes, such as bacteria, that live within or on the body of the multicellular organism.

The methods discussed in the previous paragraph may involve obtaining the prevalence of the genomes of the population in the mixed sample in the form of optimised proportion values as described previously in this specification. The methods discussed in the previous paragraph may further comprise obtaining at least one set of comparative expression levels of the related genes or the related genetic pathways in at least one additional mixed population and comparing the expression levels with the at least one set of comparative expression levels, thereby facilitating analysis of effects on the expression levels in correlation with the prevalence in the mixed population of one or more members of the mixed population. The methods discussed in the previous paragraph may also further comprise identifying a member of the mixed population whose genome comprises a gene or genetic pathway which is highly expressed and is one of the related genes or the related genetic pathways. A highly expressed gene may be, e.g., a gene with above-average or above-median expression, or expression in the top quartile, decile, or percentile, in the top 1000^{th}, 10000^{th}, 100000^{th}, or the highest overall expression either in terms of absolute amount or amount relative to the proportion of the corresponding genome in the sample.

Systems for implementing the method of the invention may consist of small stand alone systems suited to use in the field, large systems suitable for detailed analysis, distributed systems or hybrid systems consisting of a small system that can access remote processing power as required.

A small stand alone system for determining the genomic population distribution of a physical sample may include a laptop computer and a portable sequencer, such as a nanopore sensor as produced by Oxford Nanopore Technologies Ltd to obtain reads from a sample. The laptop may have a local database of reference genome segments stored on local storage media. The laptop processor may determine proportion values of the reference genomes occurring in the sample by optimising the proportion values using methods as described above. In particular the laptop may utilise algorithms most suited to the processing capabilities of the laptop, the reference genomes stored locally and other metrics such as the number of segments in the sample; the number of segments in the genomes; the number of genomes; the nature of the sample; and the required confidence level for the proportion values.

Where the proportion values cannot be determined locally to a desired confidence level, or where additional processing is desired, further processing may be transferred to a remote computer system having greater processing power and/or a larger database of reference genomes. To reduce the amount of data required to be sent only selected reads may be sent for further processing. This could be all unmapped reads or where reads have been categorised only reads of certain categories may be sent for further processing (such as exons).

Any computer system may display results in a manner enabling visual display of the results. This could simply be a bar graph showing proportions or concentrations of monitored genomes. Alternatively a more complex display technique could be employed to facilitate exploration of the results—for example a shape could be displayed representing probability levels for different proportion values with the proportion values for different genomes displayed simultaneously. By allowing a user to navigate over the surface the user may explore different proportion values that are possible within a probability range.

There is thus provided a population based method for evaluating genomic sequences that can quickly and simultaneously provide population information for all genomes and better assess the prevalence of a target genome.

### Listing of Embodiments

1. A method of evaluating the prevalence of a plurality of genomes in a sample, comprising using a processing engine to optimise estimated proportion values for the plurality of genomes based on input data comprising the prevalence of segments in the sample and the prevalence of the segments in the plurality of genomes, thereby producing optimised proportion values for the prevalence of the plurality of the genomes in the sample.
2. The method of embodiment 1 wherein the sample comprises biological sequence data stored in a computer-readable medium.
3. The method of any one of the preceding embodiments wherein a probability function is employed to optimise the proportion values.
4. The method of any one of the preceding embodiments wherein the estimated proportion values are optimised iteratively.
5. The method of embodiment 4 wherein iteration is automated according to an algorithm.
6. The method of any one of embodiments 3 to 5 wherein the probability function is optimised by moving the iteration in a direction in which the derivative of the probability function is most strongly increasing.
7. The method of any one of embodiments 4 to 6 wherein an iteration step size is determined based on the second derivative of the probability function.
8. The method of any one of embodiments 4 to 7 wherein an iteration step size is determined based on the second derivative of the probability function in the direction that the derivative is most strongly increasing.
9. The method of any one of embodiments 3 to 8 wherein the probability function is a Poisson distribution.
10. The method of any one of embodiments 3 to 9 wherein the negative log of a global probability function is minimised.
11. The method of embodiment 10 wherein the first partial derivatives of the global probability function are minimised.
12. The method of embodiment 11 wherein the first partial derivatives are minimised using a direct non-linear technique or a multidimensional Newtons technique.
13. The method of any one of embodiments 1 to 8 wherein the estimated proportion values are obtained by a maximisation function.
14. The method of any one of embodiments 4 to 13 wherein a Hessian matrix is used to determine iteration direction and step size.
15. The method of any one of the preceding embodiments wherein the input data further comprises prevalence of variants of the segments in the plurality of genomes.
16. The method of embodiment 15 wherein the variants of the segments comprise variants with indels or substitutions relative to the segments.
17. The method of embodiment 15 or embodiment 16 wherein the input data further comprises the prevalence of reverse complements of the segments or variants in the plurality of genomes.
18. The method of any one of embodiments 15 to 17 wherein each variant is associated with a weighting representing the likelihood of the respective variant occurring.
19. The method of any one of embodiments 1 or 3 to 18 wherein the sample comprises biological macromolecules.
20. The method of embodiment 19 wherein the input data further comprises prevalence of variants of the segments in the plurality of genomes, each variant is associated with a weighting representing the likelihood of the respective variant occurring, and the likelihood is based at least in part on the apparatus employed.
21. The method of embodiment 19 wherein the input data further comprises prevalence of variants of the segments in the plurality of genomes, each variant is associated with a weighting representing the likelihood of the respective variant occurring, and the likelihood is based at least in part on the chemistry of the sample.
22. The method of any one of embodiments 19 to 21 further comprising, prior to using a processing engine to optimise estimated proportion values, determining the prevalence of the segments in the sample from frequencies of the segments in sequencing data from the sample.
23. The method of any one of the preceding embodiments wherein segments that do not correlate with the plurality of genomes (“unmapped segments”) are categorised.
24. The method of embodiment 23 wherein unmapped segments are categorised based on phylogeny.
25. The method of embodiment 23 wherein unmapped segments are categorised as exons or introns.
26. The method of embodiment 23 wherein unmapped segments are categorised as paired end reads or not paired end reads.
27. The method of any one of embodiments 23 to 26 wherein categorisation information is utilised to refine proportion values.
28. The method of any one of embodiments 23 to 27 wherein unmapped segments are assembled into composite segments consisting of two or more segments of the same category and the composite segments are utilised to refine proportion values.
29. The method of any one of the preceding embodiments wherein a plurality of algorithms is employed to optimise the estimated proportion values.
30. The method of embodiment 29 wherein the algorithms are applied in an order depending upon processing metrics.
31. The method of embodiment 30 wherein the processing metrics include one or more of: the speed of each algorithm; the precision of each algorithm; the number of segments in the sample; the number of segments in the genomes; the number of genomes; the nature of the sample; the available processing resource; and the required confidence level for the proportion values.
32. The method of any one of the preceding embodiments wherein the segments of the sample are translated into another form and compared to reference segments in that form.
33. The method of embodiment 32 wherein the sample comprises DNA segments, the DNA segments are converted to protein segments, and the prevalence of proteins encoded in the sample is determined by comparing the converted protein segments to a library of protein segments.
34. The method of any one of the preceding embodiments wherein historical probability information of prior samples is utilised to assess correlation.
35. The method of any one of embodiments 19 to 34 in which the sample is a biological sample.
36. The method of embodiment 35 in which the sample is a food sample.
37. The method of embodiment 35 in which the sample is a water sample.
38. The method of embodiment 35 in which the sample is an air sample.
39. The method of embodiment 35 to 38 further comprising determining the abundance of one or more genomes in the sample based on the optimised proportion values and the concentration of genomic material in the sample.
40. A method of evaluating the prevalence of one or more reference genomes in a sample comprising the steps of:
   a. obtaining a set of segments of the sample;
   b. identifying segments in the set which are contained in the one or more reference genomes; and
   c. maximising a probability function based on:
      i. the number of occurrences of each segment identified in step b in the one or more reference genomes, and
      ii. one or more proportion values of the one or more reference genomes in the sample,
      by optimising the one or more proportion values.
41. A method of displaying the correlation between segments and one or more reference genomes obtained by the method of any one of the preceding embodiments by displaying regions of correlation between segments and reference sequences.
42. The method of embodiment 41 wherein the method is performed using a processing engine configured to allow a user to modify parameters for one or more of the steps of the method at least in part.
43. The method of embodiment 42 wherein the modifiable parameter is read length.
44. The method of embodiment 42 wherein the modifiable parameter is population distribution.
45. The method of embodiment 42 wherein the modifiable parameter is one or more thresholds.
46. The method of embodiment 42 wherein the modifiable parameter is read variants.
47. The method of any one of embodiments 41 to 46 wherein the degree of correlation is indicated by a visual attribute of each region.
48. The method of embodiment 47 wherein the attribute is colour.
49. A method of evaluating correlation between one or more reference genomes and segments of a sample, comprising using a processing engine to evaluate a probability function based on the prevalence of the segments in a sample, the prevalence of the segments in a plurality of reference genomes and an estimated genome population distribution of the sample.
50. A sequencing-processing system for determining the genomic population distribution of a sample comprising:
   a. a sequencer to obtain reads from a sample comprising nucleic acid;
   b. a first database comprising reference genome segments; and
   c. a first processing engine configured to determine optimised proportion values of the reference genomes occurring in the sample by optimising estimated proportion values.
51. The sequencing-processing system of embodiment 50 wherein the system is configured to utilise a probability function to optimise the estimated proportion values.
52. The sequencing-processing system of any one of embodiments 50 or 51 wherein the processing engine is configured to apply a plurality of algorithms in an order depending upon processing metrics.
53. The sequencing-processing system of embodiment 52 wherein the processing metrics comprise one or more of: the number of segments in the sample; the number of segments in the genomes; the number of genomes; the nature of the sample; the available processing resource; or the required confidence level for the proportion values.
54. A distributed processing system comprising the sequencing-processing system of any one of embodiments 50 to 53 and a second system in communication with the sequencing-processing system, the second system comprising:
   a. a second database storing reference genome segments not stored in the first database; and
   b. a second processing engine for processing segments received from the first system using the second database to develop proportion values.
55. The distributed processing system of embodiment 54 wherein the distributed processing system is configured to transfer processing from the sequencing-processing system to the second system when a metric of required processing by the sequencing-processing system exceeds a threshold.
56. The distributed processing system of embodiment 55 wherein the metric is selected from: processing capacity; estimated job run time; or required proportion values confidence level.
57. The distributed processing system of any one of embodiments 54 to 56 wherein the second processing engine utilises algorithms not available to the first processing engine.
58. The system of any one of embodiments 50 to 57 further comprising a display for graphically displaying regions of correlation.
59. A method of identifying a likely source of a sample comprising:
   a. using a processing engine to obtain optimised proportion values for genomes in the sample according to the method of any one of embodiments 1 to 49; and
   b. assessing whether the sample is characteristic of the one or more sources by a process comprising comparing the optimised proportion values for the sample to characteristic genome proportion values for one or more sources.
60. The method of embodiment 59 wherein assessing whether the sample is characteristic of the one or more sources comprises determining a confidence level for the result of comparing the proportion values for the sample to characteristic genome proportion values for one or more sources.
61. A method of obtaining expression levels of related genes in a mixed population, the method comprising using a processing engine to optimise estimated proportion values for the related genes based on input data comprising the prevalence of segments of the related genes in a mixed sample, the prevalence of the segments in the genomes of the population, and the prevalence of the genomes of the population in the mixed sample, thereby producing optimised proportion values for the expression levels of the related genes in the mixed population.
62. A method of obtaining expression levels of related genetic pathways in a mixed population, the method comprising using a processing engine to optimise estimated proportion values for the related genetic pathways based on input data comprising the prevalence of segments of genes in the related genetic pathways in a mixed sample, the prevalence of the segments in the genomes of the population, and the prevalence of the genomes of the population in the mixed sample, thereby producing optimised proportion values for the expression levels of the related genetic pathways in the mixed population.
63. The method of any one of embodiments 61 or 62 wherein the prevalence of the genomes of the population in the mixed sample is obtained in the form of optimised proportion values according to the method of any one of embodiments 1 to 39.
64. The method of any one of embodiments 61 to 63 further comprising obtaining at least one set of comparative expression levels of the related genes or the related genetic pathways in at least one additional mixed population and comparing the expression levels with the at least one set of comparative expression levels, thereby facilitating analysis of effects on the expression levels in correlation with the prevalence in the mixed population of one or more members of the mixed population.
65. The method of any one of embodiments 61 to 64 further comprising identifying a member of the mixed population whose genome comprises a gene or genetic pathway which is highly expressed and is one of the related genes or the related genetic pathways.
66. A method of evaluating the prevalence of a plurality of proteins in a sample, wherein the sample comprises DNA or RNA segments, the DNA or RNA segments are converted to protein segments, and the prevalence of proteins encoded or expressed in the sample is determined by a process comprising using a processing engine to optimise estimated proportion values for the plurality of proteins based on input data comprising the prevalence of the protein segments in the sample and the prevalence of the segments in a library of protein segments, thereby producing optimised proportion values for the prevalence of the proteins in the sample.
67. A method of evaluating the prevalence of a plurality of splice variants in a sample, wherein the sample comprises RNA segments, the RNA segments are optionally converted to protein segments, and the prevalence of splice variants expressed in the sample is determined by a process comprising using a processing engine to optimise estimated proportion values for the splice variants based on input data comprising the prevalence of the RNA or protein segments in the sample and the prevalence of the segments in a library of RNA or protein segments, thereby producing optimised proportion values for the prevalence of the splice variants in the sample.

The specific examples disclosed in this specification are to be construed as merely illustrative, and not limitative of the remainder of the disclosure in any way whatsoever. Without further elaboration, it is believed that one skilled in the art can, based on the description herein, utilise the present invention to its fullest extent.

The specification is most thoroughly understood in light of the teachings of the references cited within the specification. The embodiments within the specification provide an illustration of embodiments of the invention and should not be construed to limit the scope of the invention. The skilled artisan readily recognizes that many other embodiments are encompassed by the invention. All publications and patents cited in this disclosure are incorporated by reference in their entirety. To the extent the material incorporated by reference contradicts or is inconsistent with this specification, the specification will supersede any such material. The citation of any references herein is not an admission that such references are prior art to the present invention.

Unless otherwise indicated, all numbers used in the specification, including claims, to refer to quantitative parameters are to be understood as approximations and may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. The recitation of series of numbers with differing amounts of significant digits in the specification is not to be construed as implying that numbers with fewer significant digits given have the same precision as numbers with more significant digits given.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.”

Unless otherwise indicated, the terms “at least” or “one or more” preceding a series of elements are to be understood to refer to every element in the series. Those skilled in the art will recognize, or be able to ascertain using no more than routine experimentation, many equivalents to the specific embodiments of the invention described herein. Such equivalents are intended to be encompassed by the following claims.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of evaluating the prevalence of a plurality of genomes in a sample, comprising using a processing engine to optimise estimated proportion values for the plurality of genomes based on input data comprising the prevalence of the segments in the sample and the prevalence of the segments in the plurality of genomes, thereby producing optimised proportion values for the prevalence of the plurality of the genomes in the sample.

2. The method of claim 1 wherein the sample comprises biological sequence data stored in a computer-readable medium.

3. The method of claim 1 wherein a probability function is employed to optimise the proportion values.

4. The method of claim 1 wherein the estimated proportion values are optimised iteratively.

5. The method of claim 4 wherein a probability function is employed to optimise the proportion values by moving the iteration in a direction in which the derivative of the probability function is most strongly increasing.

6. The method of claim 4 wherein an iteration step size is determined based on the second derivative of the probability function.

7. The method of claim 2 wherein the probability function is a Poisson distribution.

8. The method of claim 7 wherein the negative log of a global probability function is minimised.

9. The method of claim 8 wherein the first partial derivatives of the global probability function are minimised using a direct non-linear technique or a multidimensional Newtons technique.

10. The method of claim 4 wherein a Hessian matrix is used to determine iteration direction and step size.

11. The method of claim 1 wherein the input data further comprises prevalence of variants of the segments in the plurality of genomes.

12. The method of claim 11 wherein the variants of the segments comprise variants with indels or substitutions relative to the segments.

13. The method of claim 11 wherein each variant is associated with a weighting representing the likelihood of the respective variant occurring.

14. The method of claim 1 wherein the sample comprises biological macromolecules.

15. The method of claim 14 further comprising, prior to using a processing engine to optimise estimated proportion values, determining the prevalence of the segments in the sample from frequencies of the segments in sequencing data from the sample.

16. The method of claim 1 wherein segments that do not correlate with the plurality of genomes (“unmapped segments”) are categorised as paired end reads or not paired end reads and categorisation information is utilised to refine proportion values.

17. The method of claim 1 wherein a plurality of algorithms is employed to determine proportion values.

18. The method of claim 17 wherein the algorithms are applied in an order depending upon one or more processing metrics comprising: the speed of each algorithm; the precision of each algorithm; the number of segments in the sample; the number of segments in the genomes; the number of genomes; the nature of the sample; the available processing resource; and the required confidence level for the proportion values.

19. The method of claim 1 wherein the sample comprises DNA segments, the DNA segments are converted to protein segments, and the prevalence of proteins encoded in the sample is determined by comparing the converted protein segments to a library of protein segments.

20. The method of claim 14 in which the sample is a biological sample.

21. The method of claim 20 in which the sample is a food, water, or air sample.

22. The method of claim 20 further comprising determining the abundance of one or more genomes in the sample based on the optimised proportion values and the concentration of genomic material in the sample.

23. A method of evaluating the prevalence of one or more reference genomes in a sample comprising the steps of:
a. obtaining a set of segments of the sample;
b. identifying segments in the set which are contained in the one or more reference genomes; and
c. maximising a probability function based on:
i. the number of occurrences of each segment identified in step b in the one or more reference genomes, and
ii. one or more proportion values of the one or more reference genomes in the sample,
by optimising the one or more proportion values.

24. A method of evaluating correlation between one or more reference genomes and segments of a sample, comprising using a processing engine to evaluate a probability function based on the prevalence of the segments in a sample, the prevalence of the segments in a plurality of reference genomes and an estimated genome population distribution of the sample.

25. A sequencing-processing system for determining the genomic population distribution of a sample comprising:
a. a sequencer to obtain reads from a sample comprising nucleic acid;
b. a first database comprising reference genome segments; and
c. a first processing engine configured to determine optimised proportion values of the reference genomes occurring in the sample by optimising estimated proportion values.

26. The sequencing-processing system of claim 25 wherein the system is configured to utilise a probability function to optimise the estimated proportion values.

27. The sequencing-processing system of claim 25 wherein the processing engine is configured to apply a plurality of algorithms in an order depending upon processing metrics comprising one or more of: the number of segments in the sample; the number of segments in the genomes; the number of genomes; the nature of the sample; the available processing resource; or the required confidence level for the proportion values.

28. A distributed processing system comprising the sequencing-processing system of claim 25 and a second system in communication with the sequencing-processing system, the second system comprising:
a. a second database storing reference genome segments not stored in the first database; and
b. a second processing engine for processing segments received from the first system using the second database to develop proportion values.

29. The distributed processing system of claim 28 wherein the distributed processing system is configured to transfer processing from the sequencing-processing system to the second system when a metric of required processing by the sequencing-processing system exceeds a threshold, wherein the metric is selected from: processing capacity; estimated job run time; or required proportion values confidence level.

30. A method of identifying a likely source of a sample comprising:
a. using a processing engine to obtain proportion values for genomes in the sample according to the method of claim 1; and
b. assessing whether the sample is characteristic of the one or more sources by a process comprising comparing the proportion values for the sample to characteristic genome proportion values for one or more sources.

31. The method of claim 30 wherein assessing whether the sample is characteristic of the one or more sources comprises determining a confidence level for the result of comparing the proportion values for the sample to characteristic genome proportion values for one or more sources.
